(19) United States
(12) Patent Application Publication
(10) Pub. No.: US 2002/0048224 A1
(43) Pub. Date: Apr. 25, 2002

(54) Playback device having text display and communication with remote database of titles

(76) Inventors: Timothy W. Dygert, Columbia City, IN (US); Sethu K. Madhavan, Naperville, IL (US); Gerard V. Talatinian, Indianapolis, IN (US)

Correspondence Address: STAAS & HALSEY LLP, 700 11TH STREET, NW, SUITE 500, WASHINGTON, DC, 20001, US

(21) Appl. No.: 09/976,038

(22) Filed: Oct. 15, 2001

Related U.S. Application Data
(63) Continuation-in-part of application No. 09/227,086, filed on Jan. 5, 1999.

(51) Int. Cl. H04B 1/20

(52) U.S. Cl. 369/1

(57) ABSTRACT

A multi-function consumer music system includes one or more of a disc drive, e.g., for CDs, non-volatile storage for textual title and track information about the CDs and storing recorded content, and a communication link to receive broadcast or direct transmissions of recorded content. Also included is a communication device, such as an interface to a cellular telephone, an 802.11b network, or a Bluetooth network, that communicates with a remote database to obtain the textual information and a link to cover art from the remote database and displays the obtained data (plus the cover art obtained using the link) to the user. If recorded content is played back to the user when the system is not in communication with the remote database, information for identifying the content is stored and requested when the system is back in communication with the database.

### CROSS-REFERENCE TO RELATED APPLICATIONS

This application is a Continuation-in-Part of co-pending U.S. patent application Ser. No.: 09/227,086, filed Jan. 5, 1999, hereby incorporated by reference.

### BACKGROUND OF THE INVENTION

1. Field of the Invention

The present invention is directed to an apparatus for reproducing at least audio signals and, more particularly, for an apparatus that displays the title of the recording being reproduced and obtains the titles by communicating with a remote database.

2. Description of the Related Art

Compact discs (CD) have been available to consumers for over ten years and individual collections of hundreds of CDs are not uncommon. As prices have declined, sales have increased for CD changers capable of storing and selectively playing one hundred or more CDs. However, a significant drawback has held back the success of this type of CD changer; with so many recordings out of sight in a single device, selecting a desired recording is not easily accomplished. Typical CD changers do not provide any convenient method for cataloging the CD collection or tracking internal rearrangement of the current collection.

The problem is not limited to music CDs. The CD format is used for other types of sound recordings, as well as graphics (CD-G), video (CD Video) and computer accessible data and programs (CD-ROM, CD-R, etc.). Other formats, such as MiniDiscs™ and digital video (or versatile) discs (DVDs) have received varied acceptance by consumers and playback devices for these formats would have similar problems.

Some of the tools to solve the problem are available. Some CD players are capable of storing textual information about the discs, but the interface used is so cumbersome that relatively few users enter all of the information that is available from other sources. Specifically, computer databases of CD title and track information have been available for over five years. For example, CDDB is a consumer supported database accessed via the Internet by over 300 programs to display CD title and track information of CDs played using the CD drive of a personal computer. These programs automatically contact CDDB to obtain title and track information about a CD when it is first played and store the information for subsequent times that the CD is played. Different vendors have sold systems, such as TuneBase™ and TuneBasic™ from Escient, for several years that provide a local database for conventional music or audio/video systems by interfacing with CD changers that store one hundred or more CDs. However, all of these solutions require the power (and cost) of a computer, preferably with a connection to the Internet to obtain up-to-date CD title and track information.

U.S. Pat. No. 5,751,672 to Yankowski discloses two embodiments of a system that includes a CD changer and a modem for communication with a remote database of CD title and track information. The first embodiment of the '672 patent utilizes a separate computer, like the systems described in the preceding paragraph. The second embodiment of the '672 patent incorporates at least an internal modem and communication software in a CD changer to obtain CD title and track information for a recording that is being played. A variation of the second embodiment of the '672 patent incorporates “mass storage” in the CD changer to maintain a local database of the CDs in the changer, like the databases stored in computers and other systems that access CDDB. However, even the simplest embodiment disclosed in the '672 patent still requires all the hardware and software to communicate with a remote database by a modem. An ISDN terminal adapter is the only alternative to a modem taught by the '672 patent.

As newer media for storage and transmission of recordings (both musical and spoken word) have been developed, some of the drawbacks described above have been overcome. For example, satellite digital radio broadcasts have the capability of providing information about the artist with the content and some MP3 files, have an ID3 tag that provides information about the recording. However, there a large numbers of MP3 files and other sources of recorded content that does not include significant information about the content and when provided may not be reliable.

### SUMMARY OF THE INVENTION

It is an object of the present invention to provide a playback device with enhanced capabilities.

It is another object of the present invention to provide a recording reproduction apparatus capable of displaying textual information about recordings, obtained from a remote database without requiring a modem.

The above objects can be attained by an apparatus for playback of recordings and communication with a remote database to obtain information about the recordings and provide at least textual data for a display unit, including a recorded signal output device to reproduce a recorded signal from a recording; a video output to provide the textual data to the display unit; a memory to store a textual recording name of the recording and indicating data, obtained from the recorded signal output device, that can be used for identification of the recording; a communication device, occasionally in communication with the remote database, to obtain the textual recording name by sending the indicating data to the remote database; and a controller, coupled to the recorded signal output device, the video output, the memory and the communication device, to control the apparatus to play back the recording regardless of whether the communication device is in communication with the remote database, to repeatedly try to establish communication with the remote database unit communication is established, to query the remote database using the indicating data when communication is established and to supply the textual recording name of the recording from the remote database to the memory.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a system according to the present invention;

FIG. 2 is an example of information stored in volatile memory;

FIG. 3 is an entry for a track in the table of contents in the lead-in area of a conventional compact disc;

FIG. 4 is an example of information stored in non-volatile memory;

FIG. 5 is a disc information structure record in non-volatile memory; and

FIG. 6 is a block diagram of variations of the basic embodiment.

### DETAILED DESCRIPTION OF THE PREFERRED EMBODIMENTS

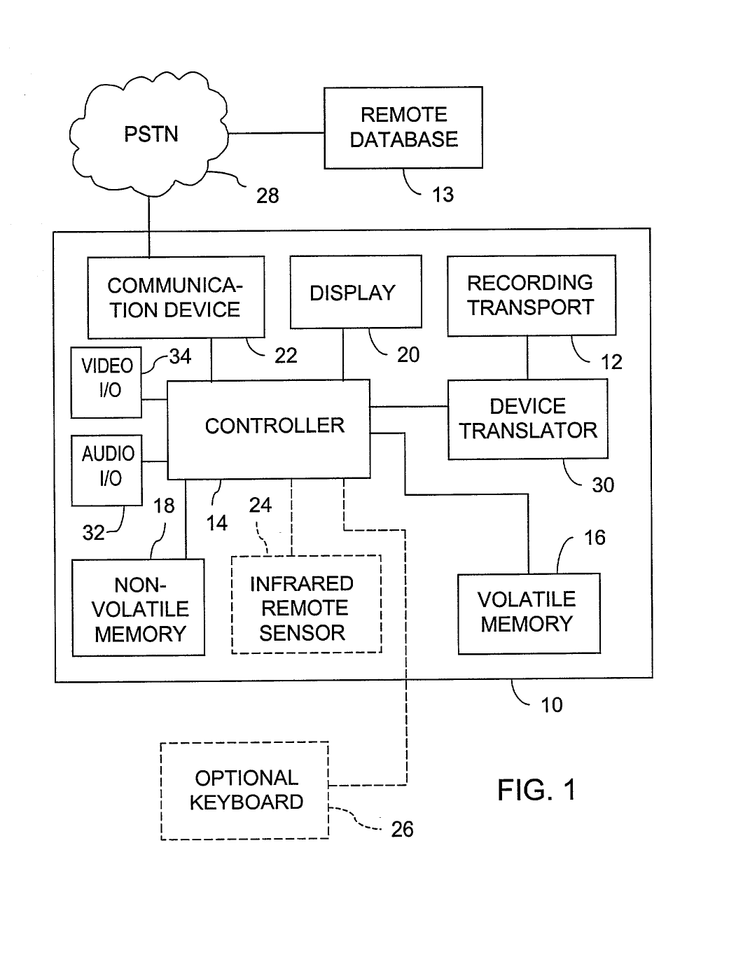

Illustrated in FIG. 1 is a block diagram of an apparatus according to the basic invention. An enclosure 10 surrounds recording transport 12 and controller 14 of the apparatus. Controller 14 is coupled to recording transport 12 and both volatile memory 16 and non-volatile memory 18. Mounted at the surface of the enclosure 10 are display 20 and communication device 22, both of which are also coupled to controller 14. One or more user interface devices are also connected to controller 14, such as infrared remote sensor 24 or keyboard 26 which may be external to the apparatus as illustrated in FIG. 1, or a smaller keypad mounted at the surface of the apparatus. Audio 32 and video 34 input/output interface(s) enable the apparatus to be coupled to other devices, such as televisions, amplifiers, speakers, etc. Any conventional physical interface may be used, including S/PDIF, RCA jacks, etc.

Recording transport 12 may be any conventional recorded signal output device. If the recordings are stored on removable media, recording transport 12 includes at least the ability to mount and eject the recordings and supply the recorded signals stored on the recordings to controller 14 via device translator 30. In the basic invention, enclosure 10 will be used to store multiple recordings and recording transport 12 will move the recordings between their storage locations and a playback area. The present invention may be used for compact discs, DVDs, MiniDiscs™, or even non-disc removable media, such as tapes or solid state memory, or hard disks, whether permanent or removable. Device translator 30 performs data manipulation to provide data stream(s) expected by the controller. For example, a recorded audio signal may be separated from control information or other data signals, such as the TOC data.

The present invention is not limited to music recordings, but may used with spoken word, video and data recordings where additional information about the recordings is stored in a remote database 13. The recorded signals include anything stored on the recordings, including control information, such as table of contents (TOC) data. In the following description, the term compact disc or its abbreviation CD often will be used interchangeably with “recording” since CDs are commonly used recordings today. Thus, recording transport 12 may be a CD changer mechanism.

Controller 14 may be any suitable control device, such as Microchip PIC16C67 or Motorola 6805 or the controller used in conventional changers. An advantage to using a programmable controller like the PIC16C67 is that it is possible to download a new program for controller 14 to change the operation of the apparatus, as described below. Furthermore, more than one device may be used to perform the functions of controller 14. For example, conventional CD changer operations may be performed by one device and the processing of disc IDs and database queries described below may be performed by a second device which is more likely to be programmable.

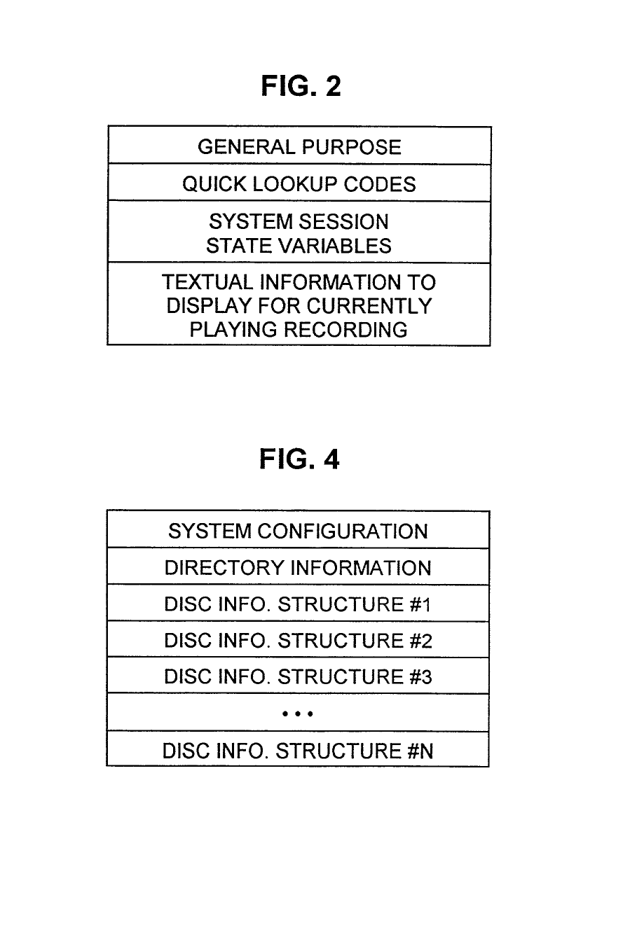

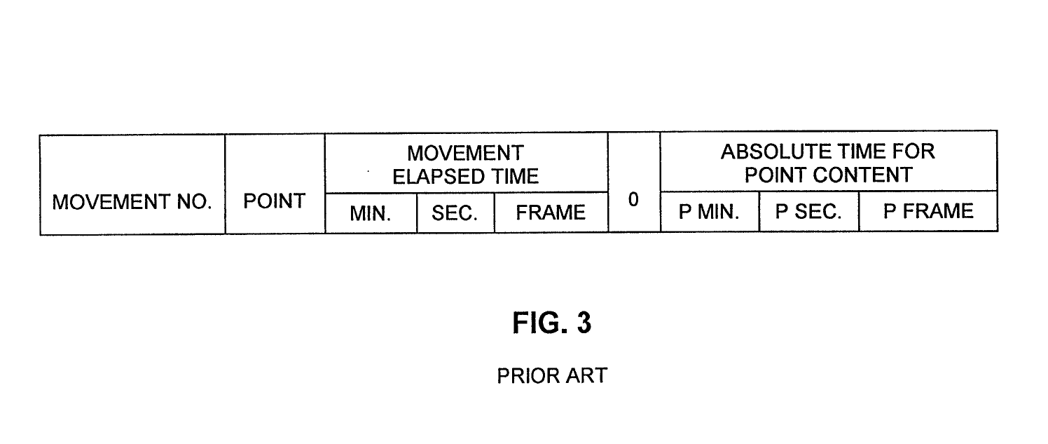

Volatile memory 16 may be used for storing information obtained from the recorded signal output by recording transport 12, such as information obtained from the table of contents or TOC on the recording. An example of what is stored in volatile memory 16 is illustrated in FIG. 2. The TOC of CDs, for example, as described in chapter 5 of Compact Disc Technology, by Heitaro Nakajima and Hiroshi Ogawa published in 1992 by Ohmsha, Ltd., 3-1 Kanda Nishiki-cho, Chiyoda-ku, Tokyo 101, Japan, has entries for each track in the format illustrated in FIG. 3 repeated as many times as possible in the lead-in area at the beginning of the CD. Volatile memory 16 may be provided by any conventional semiconductor random access memory.

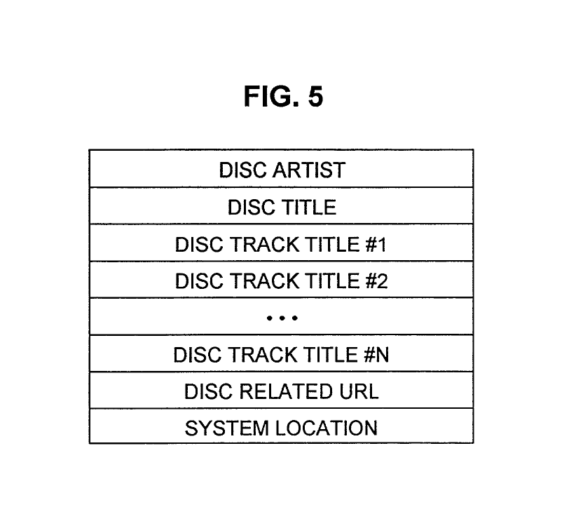

A database of textual information about CDs that have been played or stored in enclosure 10 is maintained in non-volatile memory 18, as illustrated in FIG. 4, with a typical record layout in FIG. 5. In addition, non-volatile memory 18 may store the program for controller 12 and other information. Non-volatile memory 18 may be provided by electrically erasable programmable read-only memory (EEPROM) or semiconductor random access memory with a battery backup, or magnetic storage, such as a small hard drive, or any other conventional non-volatile memory.

Display 20 may be any conventional display capable of displaying a sufficient amount of textual information to enable a user to read the title of the recording and, preferably, the tracks or segments of the recording also. For example, a liquid crystal display (LCD) having sufficient segments to display twenty to eighty letters on one or more lines mounted at the surface of enclosure 10 would be adequate. However, display 20 may be able to display many more characters and possibly graphics also, or a smaller number of characters could be used in a scrolling display.

According to the present invention, communication device 22 may be provided by many different types of devices. To minimize cost in the basic invention, communication device 22 is preferably not a conventional analog modulator/demodulator (modem) or an ISDN terminal adapter. The device that can be most widely used is a dual-tone multifrequency (DTMF) generator and detector, such as a Xecom DTMF transceiver, or a similar product from Mitel, coupled to a conventional RJ11 jack. This embodiment permits the apparatus to be connected to any phone line, e.g., the public switched telephone network (PSTN) 28. The remote database 13 will need a front-end processor that can communicate using DTMF signaling, but that can be provided by a general purpose computer connected to a plurality of DTMF transceiver for handling multiple calls.

A second embodiment of communication device 22 uses an industry standard interface, such as one of the standards set by the Electronic Industry Association and the Institute of Electrical and Electronics Engineers, e.g., EIA's RS-232 or IEEE 1394. Other alternatives include other kinds of jacks, such as coaxial and optical, and other interface specifications, such as Ethernet and proprietary interfaces. Even though modems are relatively inexpensive today compared to five to ten years ago, the types of interfaces suggested for use in the second embodiment can be implemented at a small fraction of the cost of a modem.

In the second embodiment, communication with the remote database 13 may use any conventional protocol, such as TCP/IP on the Internet. The industry standard (or proprietary) interface of the second embodiment is used to connect the apparatus to a device that has a connection to the Internet and accepts data from another device, but is not required to perform any functions regarding matching the information read from the recording with a database of textual information, since those functions are performed by the apparatus and at the remote database 13. For example, existing devices used to provide Internet connections via cable or satellite could be used with little or no modification, since all that is necessary is to transfer the data to and from the apparatus. Similarly, a general purpose computer could be programmed to treat the apparatus as a terminal that is to communicate with the Internet via any conventional connection to the Internet that the computer may have (dial up, local area network, dedicated line, etc.). The external device used in the second embodiment and its connections to remote database 13 takes the place of the PSTN 28 in FIG. 1.

In a third embodiment, communication device 22 may be directly connected to a local area network (LAN) that has a conventional connection to the Internet, or some other connection to the remote database 13. For example, the remote database 13 may be stored on a computer directly connected to the local area network, or via a wide area network (WAN) or other private network, as opposed to the public computer network commonly referred to as the Internet. Examples of LAN and WAN technology include wired and wireless networks such as Ethernet, FDDI, ATM, 802.11a/b, Bluetooth, leased lines, satellite connections and communication over power lines (such as HomePlug). In these examples, either communication device 22, or controller 14 includes programming to implement a conventional protocol, such as a TCP/IP stack, for communication over a public computer network, e.g., the Internet, or the local/wide area network. As in the case of the second embodiment, PSTN 28 in FIG. 1 would be replaced with the public or private network(s).

### Basic Invention

The operation of the basic invention will now be described with reference to FIGS. 2-5. When recording transport 12 first accesses a recording, the TOC is read in a conventional manner. An example of the contents of the TOC is illustrated in FIG. 5. As described in U.S. Pat. No. 5,751,672, incorporated herein by reference, the TOC information is sufficient to identify most CDs. However, contrary to the statements in the '672 patent, practical experience has found that rather than attempting to determine a “unique fingerprint” that works for all CDs, it is best to use fuzzy matching techniques, such as those disclosed in U.S. Pat. No. 6,061,680, incorporated herein by reference. Controller 14 receives the information from the TOC via device translator 30 and executes an algorithm to generate a disc ID for comparison with the disc IDs in the database stored in non-volatile memory 18.

At the present time, a large database of CD and track titles is available via the Internet from CDDB. Using this database as an example, controller 14 generates the disc ID by calculating the offset from the beginning of the CD to the beginning of second through the last track in frames (each CD has 75 frames per second). To calculate the first byte of the disc ID, the offsets are converted to seconds and the offset to the beginning of the first track is incremented by two seconds, representing a lead-in time. The digits of the offsets (plus lead-in time for the first track) in seconds are summed for the first byte. The second and third bytes of the disc ID are the entire running time in seconds which is the sum of the offset to the last track plus the playing time of the last track. The last byte of the disc ID is the number of tracks on the CD.

For example, a CD with six tracks having the following track times in minutes and seconds: 20:38, 3:34, 3:20, 3:52, 3:35, and 3:59; or in seconds: 1238, 214, 200, 232, 215, and 239 has a total track time as follows:

1238+214+200+232+215+239=2338 (or 0922 hex), 1238 1452 1652 1884 2099 2338 (running sum)

To calculate the first byte, the lead-in time of 2 seconds is added to the running time of the first track and the sum of the digits is calculated as follows:

1240->1+2+4=7 (running sum: 9)

1454->1+4+5+4=14 (running sum: 23)

1654->1+6+5+4=16 (running sum: 39)

1886->1+8+8+6=23 (running sum: 62)

2101->2+1+0+1=4 (running sum: 66, or 42 hex)

Thus, the disc ID is 42092206.

If there is a match for the disc ID in the local database stored in non-volatile memory 18, the textual information about the CD is displayed on display 20. If the disc ID is not found in the local database, a query is formulated for the remote database 13. Because CDDB accepts information from users of the system, a verification of the disc ID calculation may be used when querying the CDDB database. The preferred CDDB query format is:

CDDB QUERY<discid><num tracks><offset_{—}1>. . . <offset_n><total secs>with the offsets in frames and the total number of seconds (total secs) including the lead-in time. Thus, the preferred CDDB query for the above example is:

CDDB QUERY 42092206 6 183 93015 109098 124058 141515 157608 2340.

The query is sent to the remote database 13 by communication device 22. In the first embodiment communication device 22 is connected to the public switched telephone network (PSTN) 28 and its telephony components described above take the phone line off-hook and dial one or more stored numbers for a computer on which the remote database 13 is maintained. The query is then transmitted to a front end processor (not shown separately) for remote database 13. Conventional DTMF signals provide 16 unique tones representing, 0-9,, # and A-D (which are defined, even though they are not available on most phones) that can be transmitted at the rate of 20 tones per second. Thus, the front-end processor for the remote database 13 can formulate the query from hexadecimal codes transmitted from communication device 22. In the second and third embodiments, a conventional query may be sent to the external device connected to the Internet which takes the place of PSTN 28, as described above.

Once communication with the remote database 13 is established, the query described above is sent and one of three responses is received from the remote database 13: (1) there is a single match; (2) there are multiple matches; or (3) no match is found. In case (1), the user is prompted to confirm that the correct CD was found and if so, the textual information received from the remote database 13 is stored in non-volatile memory 18 and sent to display 20. In case (2), the user is prompted to select one of the CD titles or indicate that none is correct. If one is selected, the textual information for the selected CD is stored in non-volatile memory 18 and sent to display 20. In case (3), or if the correct title is not provided in case (1) or (2), the user may given the option of playing without textual information, or inputting the title using one of the conventional techniques.

Preferably, the local database in non-volatile storage 18 maintains a record of all CDs that have ever been stored in the CD changer, until memory capacity has been reached. Therefore, the last field in the record layout illustrated in FIG. 4 may have a value indicating that the CD is not presently stored in the CD changer. Thus, when a CD is removed from the CD changer and then replaced, controller 14 will find a match for the disc ID of the CD in the local database in non-volatile memory 18 and will update the system location in the matching record with the new location of the CD.

### Alternative Embodiments

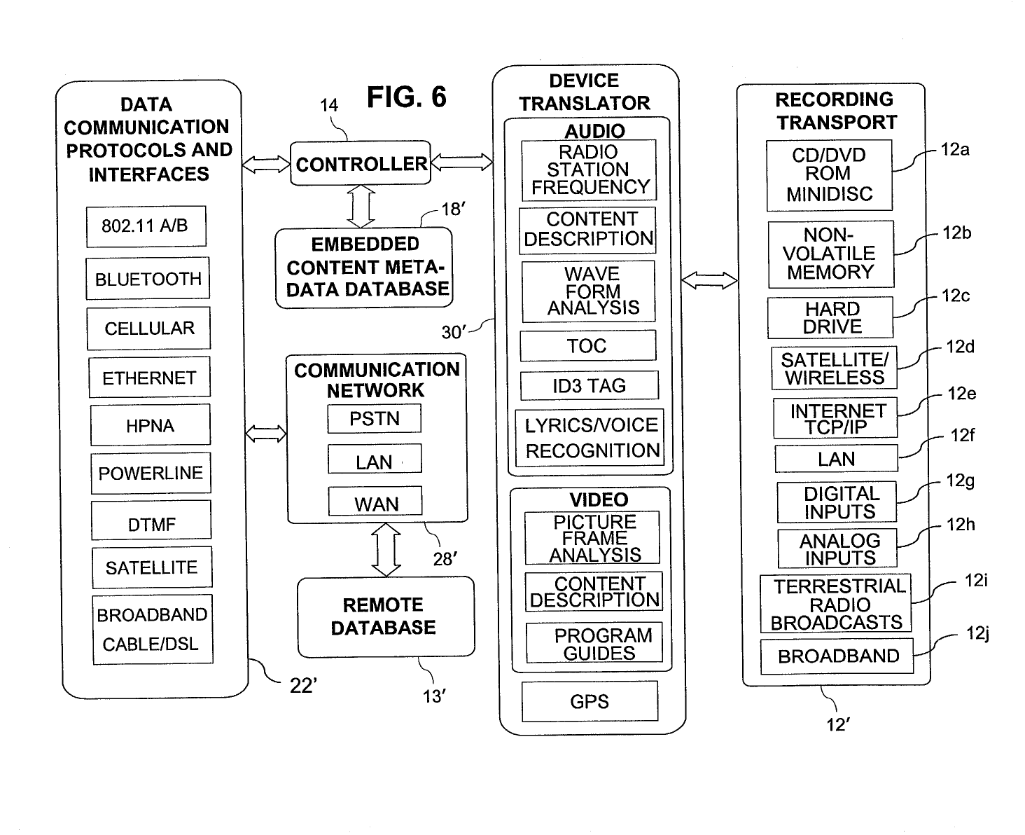

In the basic invention, recording transport 12 is typically a changer mechanism that accepts at least compact discs. Thus, it was assumed that TOC data was available. As illustrated in FIG. 6, in the alternative embodiments recording transport 12′ may include nonvolatile memory 12b or hard drive 12c, or a communication link to receive a recording via broadcast or direct connection. Many forms of recorded content received from these alternatives do not have TOC data that can be used to identify the recording. When the recordings do not contain TOC data, other techniques must be used for feature extraction and analysis to obtain information that can be used to identify recordings. The data output by device translator 30′ is sent to controller 14 for forwarding to the remote database 13′ via communication device 22′.

Communication device 22′ provides the hardware and data processing for one or more of the data communication protocols and interfaces illustrated in FIG. 6. In addition to connecting to remote database 13′ via communication network 28′, these interfaces may be used to connect to other devices located where apparatus 10 is installed. Some of the devices to which apparatus 10 can be connected are described in the examples provided below.

Remote database 13′ performs media recognition and database lookup of metadata is performed. Examples of information that can be used for feature extraction and analysis include radio station frequency, content description, etc., as listed in the block for device translator 30′ in FIG. 6. These examples are discussed in more detail below.

Several of the alternatives for recording transport 12′ provide direct connections to recorded content, e.g., disc drive(s) 12a, non-volatile memory 12b, and hard drive 12c which may be fixed or removable magnetic or magneto-optical storage devices attached via IDE, SCSI, USB1/2, and IEEE-1394 busses. Examples of non-volatile memory 12b include Compact Flash (CF) cards, Secure Data Cards (SD), Multimedia Storage Cards (MMC), Smart Cards, and Memory Sticks. In addition, digital inputs 12g and analog inputs 12h may be used to connect directly to external audio and video devices using standards-based digital audio and video interconnect interfaces, including S/PDIF for audio, IEEE-1394 AV link for video and audio, stereo L/R audio via RCA connectors, analog composite (NTSC) video via RCA connectors, and S-Video (Y/C) analog video signals, as well as equivalents for the PAL television standard.

Other alternatives for recording transport 12′ provide a communication link. Satellite/wireless communications 12d may deliver a broadcast or provide a direct link via digital or analog satellite broadcast systems, such as DirectTV, and satellite radio services. Internet TCP/IP 12e and LAN 12f may be used to deliver content over TCP/IP packed based networks, including intranets, extranets, and the public Internet. Data is delivered as a file download or as streaming digital compressed or uncompressed audio and video data from servers on the packet network. Terrestrial wireless broadcast 12i delivers content using radio frequency wireless broadcast channels, including analog audio FM and AM broadcasts, NTSC video broadcasts, and HDTV broadcasts. Broadband 12j includes terrestrial cable using radio frequency over coax cable channels, such as digital audio channels, analog NTSC video channels, and digital video channels.

The various alternative recording transports require different device translation services. For terrestrial radio feeds, broadcast frequency information, used in conjunction with frequency band information, modulation scheme, geographical location, and time of day is analyzed. For content with embedded metadata, such as enhanced MP3, MPEG1/2 audio streams, the metadata is extracted and filtered further. The collected data is formatted appropriately and forwarded to controller 14. For both analog and digital audio signals, raw signal data is used as input and key features such as frequency content is extracted. For MP3 content, ID3 tag data is extracted and filtered. Content lyrics or spoken words can be extracted using voice recognition. In the case of recorded video, image analysis techniques may be used for scene information extraction, e.g., color content, object shape and movement analysis. Alternatively, data included in the broadcast signal to describe the content may be collected and filtered. Finally, program metadata for the content currently being viewed may be collected and filtered for comparison with a guide to what is on each channel by time that is provided either through the public network (Internet) or as information in the broadcast stream. In all of the above examples, the collected data is formatted appropriately and forwarded to controller 14.

Many different types of devices can use one or more of the recording transports 12a-12g and device translation illustrated in FIG. 6. Some examples are described below.

### Car Audio with 2-way Network

The first example is an audio device for an automobile that includes a CD drive 12a capable of playing both CD-DA and MP3 (or other compressed format), an AM/FM Tuner, a Satellite Radio Receiver, a cellular two way network interface, a GPS receiver, a controller, a graphics display and a mechanism for rendering audio output from the various sources.

When a conventional audio CD (CD-DA) is inserted in the CD Player, controller 14 obtains the TOC from the CD as described above for the basic invention. Using a TCP/IP-based two way cellular network, controller 14 sends the TOC information to remote database 13 or 13′ for identification. Remote database 13 or 13′ returns the CD title, artist, track names and a link to album cover art. Controller 14 stores the returned information in database 18′ and starts retrieval of the album cover art. The album name, track names and cover art are displayed on the graphics display 20 (FIG. 1).

When the recorded content is received via an AM or FM transmission, controller 14 sends the current time, current tuned frequency, and current location (obtained from the GPS receiver) to remote database 13′ via the two way cellular network. The remote database determines the specific station being listened to by correlating the GPS coordinates and frequency. The remote database includes or has access to the playlist for the specific radio station and returns the name of the song, artist name, CD title from which song is taken (if any) and a pointer to album cover art for download, as described above. This information is displayed on the graphics display.

In the event that no playlist is available for the current station, the controller extracts a sample of the audio playback. This sample is sent to remote database 13′ via the two way cellular network. Using waveform matching or another appropriate technique, remote database 13′ is used to identify the song and return the song name and artist. This information is displayed on the graphics display.

Conventionally, satellite radio broadcasts may include the name of the song and the CD title that the song is from. This information is made available to controller 14 by the satellite tuner 12d. Controller 14 sends this information to remote database 13′ and obtains a link to the related album cover art. Controller 14 retrieves the album cover art via the cellular two way network and displays it on the graphics display along with the CD title and song name.

### Car Audio with 802.11b Network

A second example is a car radio with CD Player (CD-DA and MP3 or other compressed format) 12a, hard disk drive 12c for storing compressed media, graphics display, tuner 12i, a local area wireless network (hereafter referred to as an 802.11b network interface, but any equivalent network could be used), controller 14, and a mechanism for rendering audio output. Also included on the hard disk drive is a local metadata database 18′ containing at least a portion of the remote database 13′ at some point in time. No album cover art is contained in the embedded version of the metadata database.

In this case, when a user inserts a CD-DA disk into the CD drive 12a while the automobile is out of range of the 802.11b network, controller 14 obtains the TOC from the CD and stores it. A query is made to the local metadata database 18′ using the TOC. If the CD is found in database 18′ then the CD title, artist and song names are displayed on the graphics display. If the TOC is not found in the local metadata database then only track numbers for the CD are displayed on the graphics display.

When the automobile comes within range of the 802.11b network, e.g., while parked in the garage of the owner, controller 14 makes a request to remote database 13′ using the 8021.11b network. Remote database 13′ returns the CD title(s), track names, artist name(s) and link(s) to album cover art for any CD(s) played for the first time while the automobile was out of range of the 802.11b network. Controller 14 uses the 802.11b network connection to request the cover art. All information is stored in database 18′ in non-volatile memory which may physically be the same as non-volatile memory 12b. The next time the same CD is inserted into CD drive 12a, controller 14 access database 18′ to display the CD title, song names and album cover art on the graphics display.

When a user is listening to a song from the tuner in the automobile, the user may press a button labeled “Get Info.” This causes controller 14 to collect an audio sample of the song currently playing. When the automobile gets within range of the 802.11b network, controller 14 sends a query based on the samples to remote database 13′. Remote database 13′ sends back the song name and , if available, at least one CD title that contains the song and a link to related album cover art. This information is made available to the user on the graphics display to facilitate obtaining the song either by purchase of the CD or purchase of the song for delivery via the 802.11b network interface. If delivered via the 802.11b network interface the song will be stored on hard disk drive 12c.

When a user inserts a CD that is formatted as an ISO 9660 data CD containing songs in a compressed audio format such as MP3, the songs may, at the user's request, be copied to hard drive 12c. When the user selects one of these songs for playback, the ID3 tag can be used to identify the song title, CD name and artist. When the automobile is within range of the 802.11b network it can request the location of the album cover art for various songs from the remote database. The album cover art can be downloaded using the 802.11b network interface and stored on hard drive 12c. This data, along with the information in the ID3 tag can be displayed when the song is played.

### Digital Video Set Top Box on Cable Network

As a third example, a digital cable network interface device may include a broadband interface 12j that provides a cable modem as well as cable TV channels, controller 14, a TV output that can display both a graphical user interface and video content, and a mechanism for rendering audio and video content received over the network. When a user tunes to a specific program, controller 14 uses a program guide obtained as data over the broadcast network to identify the program that is currently playing. The program ID is sent via the cable modem interface to the remote database. Metadata including, for example, information on the actors, director, producer, story line etc, is returned from remote database 13′ and can be displayed on the television display or on a display attached to the device by command of the user. The information returned from remote database 13′ may also contain metadata about specific items shown on screen such as clothing, furniture, automobiles etc and provide information on how to purchase these items.

### Controller for Externally Stored Media

In a fourth example, controller 14, a graphics display device (including output to a TV), a powerline network interface to a home area network, non-volatile storage 12b and a control and data interface to one or more external media storage/access units are included. Further, the home area network (LAN) is connected to the public network using a home gateway device that provides access to the public network via one of several means including cable modem, digital subscriber line (DSL), dialup modem, and satellite.

When a user inserts a CD into the external changer that is connected to the device, the TOC is extracted from the CD and sent to remote database 13 or 13′ via the powerline network connection to the home area network (LAN) and whatever connection exists between a device on the LAN and remote database 13′. Remote database 13′ returns the CD title, track names, artist name and a location for the album cover art. Controller 14 requests the album cover art from the specified location and stores this along with the other data retrieved from remote database 13′ in database 18′ which uses non-volatile storage. The information is presented to the user on the graphics display and or the television connected thereto. At any future time that this same CD is selected for playback, the above information will be retrieved from the database 18′ and presented to the user on the graphics display or the television.

### Portable CD Player with Bluetooth Network Connection

In a fifth example, a portable unit includes a CD drive 12a that is capable of reading both CD-DA and MP3 files from data CDs (ISO 9660), controller 14, non-volatile memory 12b, a mechanism for rendering the content from the media, a Bluetooth network interface and a graphics display. The Bluetooth network interface may be connected via a home area network (LAN) to the Internet.

When a user inserts a CD-DA disk in CD drive 12a, controller 14 obtains the TOC from the CD. If it is in range of the Bluetooth network it sends a request to remote database 13 or 13′ to obtain the CD title, song names, artist names and a link to album cover art. If it is not in range, the TOC is stored until the device comes in range of the Bluetooth network at which time it requests the required data from remote database 13′. The information obtained from remote database 13′ is stored in database 18′ in non-volatile memory, so that subsequent insertions of the same CD will allow the information to be displayed without requiring access to remote database 13′.

When a user inserts an ISO 9660 formatted CD containing MP3 files, if the MP3 file contains an ID3 tag, controller 14 retrieves the name of the CD containing the song, the name of the song and the artist name from the ID3 tag. This information is displayed on the graphics display. The ID3 tag information is used to make a request to remote database 13′ for additional metadata on the song including, but not limited to, the location of album cover art appropriate to the song. This information is retrieved from remote database 13′, stored in database 18′ in non-volatile memory and displayed on the graphics display.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus for playback of recordings and communication with a remote database to obtain information about the recordings and provide at least textual data for a display unit, comprising:
a recorded signal output device to reproduce a recorded signal from a recording;
a video output to provide the textual data to the display unit;
a memory to store a textual recording name of the recording and indicating data, obtained from said recorded signal output device, that can be used for identification of the recording;
a communication device, occasionally in communication with the remote database, to obtain the textual recording name by sending the indicating data to the remote database; and
a controller, coupled to said recorded signal output device, said video output, said memory and said communication device, to control said apparatus to play back the recording regardless of whether said communication device is in communication with the remote database, to repeatedly try to establish communication with the remote database unit communication is established, to query the remote database using the indicating data when communication is established and to supply the textual recording name of the recording from the remote database to said memory.

2. An apparatus as recited in claim 1, wherein the communication device is a cellular two-way network interface.

3. An apparatus as recited in claim 1, wherein the communication device is an 802.11a network interface and said apparatus is mounted in an automobile.

4. An apparatus as recited in claim 1, wherein the communication device is an 802.11b network interface and said apparatus is mounted in an automobile.

5. An apparatus as recited in claim 1, wherein the communication device is a Bluetooth network interface and said apparatus is portable.
